(19) United States
(12) Patent Application Publication
(10) Pub. No.: US 2007/0242097 A1
(43) Pub. Date: Oct. 18, 2007

(54) Printing apparatus, printer controller, printer controller method

(75) Inventor: Eiji Minami, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/784,227

(22) Filed: Apr. 6, 2007

(30) Foreign Application Priority Data
Apr. 7, 2006 (JP) 2006-106377

(51) Int. Cl. B41J 29/393

(52) U.S. Cl. 347/19

(57) ABSTRACT

[Object] To provide a printing apparatus and a printing method in which printing onto a label surface can also be performed when backing up data in a non-volatile storage medium. [Solving Means] A printing apparatus includes: storage means having a first unit that holds a non-volatile storage medium therein and storing data in the non-volatile storage medium held in the first unit; printing means for printing an image on a label surface of the non-volatile storage medium whose label surface is printable; determination means for determining whether or not printing onto the label surface of the non-volatile storage medium held in the first unit is possible on the basis of a predetermined condition; mode selection means for selecting a backup print mode; and control means for, when the backup print mode is selected, controlling the storage means to store data to be backed up in the non-volatile storage medium held in the first unit, controlling the determination means to determine whether or not printing onto the label surface of the non-volatile storage medium is possible, and controlling the printing means to print an image based on the data to be backed up on the label surface of the non-volatile storage medium if the determination means determines that printing is possible and not to print the image if the determination means determines that printing is not possible.

### TECHNICAL FIELD

The present invention relates to a printing apparatus, a print control device, and a print control method.

### BACKGROUND ART

In the case of backing up data in a non-volatile storage medium having a label surface, such as CD-R or DVD-R, it becomes easy to check what data is backed up in a corresponding non-volatile storage medium if an image based on data to be backed up is printed on the label surface. In such a case, it would be convenient for a user if printing onto a label surface is also performed at the time of backup.

A printer capable of printing an image onto a surface of a non-volatile storage medium is disclosed in Patent Document 1. However, in the case of the printer disclosed in Patent Document 1, data cannot be backed up.

[Patent Document 1]JP-A-2003-251872

### DISCLOSURE OF THE INVENTION

### Problems to be Solved by the Invention

The present invention is designed to solve the above problem, and it is an object of the present invention to provide a printing apparatus capable of performing printing on a label surface when backing up data in a non-volatile storage medium, a print control device, and a print control method.

### Means for Solving the Problems

(1) A printing apparatus for achieving the above object includes: storage means having a first unit that holds a non-volatile storage medium therein and storing data in the non-volatile storage medium held in the first unit; printing means for printing an image on a label surface of the non-volatile storage medium having the printable label surface; determination means for determining whether or not printing onto the label surface of the non-volatile storage medium held in the first unit is possible; mode selection means for selecting a backup print mode; and control means for, when the backup print mode is selected, controlling the storage means to store data to be backed up in the non-volatile storage medium held in the first unit, controlling the determination means to determine whether or not printing onto the label surface of the non-volatile storage medium is possible, and controlling the printing means to print an image based on the data to be backed up on the label surface of the non-volatile storage medium if the determination means determines that printing is possible and not to print the image if the determination means determines that printing is not possible.

According to the invention, when a backup print mode is selected, data to be backed up is backed up in a non-volatile storage medium and an image based on data to be backed up is printed on a label surface of the non-volatile storage medium. Accordingly, when backing up data in a non-volatile storage medium having a label surface, printing onto a label surface can also be performed.

In addition, according to the present invention, a determination on whether or not printing onto a label surface of the non-volatile storage medium is possible is made. Accordingly, it is possible to prevent a malfunction in which an image is printed to be overwritten on a non-volatile storage medium, of which a label surface is already printed, or label surface printing is performed even if a non-volatile storage medium does not have a printable label surface.

(2) The printing apparatus may further include guidance means for guiding a user to perform an operation. The printing means may have a second unit, which is provided to hold a non-volatile storage medium having a printable label surface and is different from the first unit, and print an image on the label surface of the non-volatile storage medium held in the second unit. The control means may cause the data to be backed up to be stored in the non-volatile storage medium held in the first unit and then control the guidance means to guide the user to insert the non-volatile storage medium into the second unit if the determination means determines that printing is possible and not to guide the user if the determination means determines that printing is not possible.

According to the present invention, since data to be backed up is stored in a non-volatile storage medium held in the first unit and then a user is guided to insert the non-volatile storage medium into the second unit if it is determined that printing is possible, the user can easily see an operation that is to be performed after the data is stored. In this case, in the present invention, the guidance is not performed if it is determined that the printing is not possible. Accordingly, it is possible to prevent a wrong operation from being guided to the user.

(3) The guidance means may have display means for displaying a message and perform the guiding by displaying on the display means a message instructing the non-volatile storage medium held in the first unit to be inserted into the second unit.

(4) The determination means may specify the type of the non-volatile storage medium held in the first unit and determine that printing is possible if the specified type is a type having a printable label surface and determine that printing is not possible if the specified type is a type not having a printable label surface.

According to the present invention, it is possible to prevent a malfunction in which an image is printed on a label surface of a non-volatile storage medium that is of a type not having a label surface that can be printed by the printing means.

(5) Attribute information indicating that printing is completed may be stored in the non-volatile storage medium having a label surface on which an image has been printed. The determination means may search the non-volatile storage medium held in the first unit and determine that printing is possible if the attribute information is stored and determine that printing is not possible if the attribute information is not stored.

According to the present invention, it is possible to prevent that an image is printed to be overwritten on a non-volatile storage medium having a label surface on which an image is already printed.

(6) A print control device for achieving the above object includes: mode selection means for selecting a backup print mode; and control means for, when the backup print mode is selected, controlling storage means having a first unit that holds a non-volatile storage medium therein to store data to be backed up in the non-volatile storage medium held in the first unit, controlling determination means for determining whether or not printing onto a label surface of the non-volatile storage medium held in the first unit is possible to determine whether or not the printing onto the label surface of the non-volatile storage medium is possible, and controlling printing means for printing an image on the label surface of the non-volatile storage medium having a printable label surface to print an image based on the data to be backed up on the label surface of the non-volatile storage medium if the determination means determines that printing is possible and not to print the image if the determination means determines that printing is not possible.

According to the present invention, printing onto a label surface can also be performed when backing up data in a non-volatile storage medium.

In addition, according to the present invention, a determination on whether or not printing onto a label surface of the non-volatile storage medium is possible is made. Accordingly, it is possible to prevent a malfunction in which an image is printed to be overwritten on a non-volatile storage medium, of which a label surface is already printed, or label surface printing is performed even if a non-volatile storage medium does not have a printable label surface.

(7) A print control method for achieving the above object includes a step of selecting a backup print mode by means of mode selection means; and a step of, when the backup print mode is selected, controlling storage means having a first unit that holds a non-volatile storage medium therein to store data to be backed up in the non-volatile storage medium held in the first unit, controlling determination means for determining whether or not printing onto a label surface of the non-volatile storage medium held in the first unit is possible to determine whether or not the printing onto the label surface of the non-volatile storage medium is possible, and controlling printing means for printing an image on the label surface of the non-volatile storage medium having a printable label surface to print an image based on the data to be backed up on the label surface of the non-volatile storage medium if the determination means determines that printing is possible and not to print the image if the determination means determines that printing is not possible, by means of control means.

According to the present invention, printing onto a label surface can also be performed when backing up data in a non-volatile storage medium.

In addition, according to the present invention, a determination on whether or not printing onto a label surface of the non-volatile storage medium is possible is made. Accordingly, it is possible to prevent a malfunction in which an image is printed to be overwritten on a non-volatile storage medium, of which a label surface is already printed, or label surface printing is performed even if a non-volatile storage medium does not have a printable label surface.

In addition, each function of a plurality of means included in the present invention is realized by a hardware resource whose function is specified with the configuration itself, a hardware resource which function is specified by a program, or a combination thereof. In addition, each function of the plurality of means is not limited to being realized by hardware resources that are physically independent from each other. In addition, the order of respective operations in the method described in the appended claims is not limited thereto as long as there is no technical problem. Without being limited to the described order, the operations may be executed in any kind of order or may be executed simultaneously.

### Best Mode for Carrying Out the Invention

Hereinafter, an embodiment of the present invention will be described by way of examples.

FIG. 2 is a block diagram illustrating the configuration of a multi-function printer (MFP) 1 that is an example of a printing apparatus according to an embodiment of the present invention. The MFP 1 has a function of printing an image on the basis of image data input from a card-type flash memory 15, an optical disk 16 serving as a non-volatile storage medium having a printable label surface, a PC (personal computer), a mobile phone, a PDA (not shown), and the like, a copying function, and a function of backing up data from the card-type flash memory 15 into the optical disk 16.

A scan unit 23 includes an illumination section 28, an image sensor 25, a scan processor 26, a carriage driving section 24, and the like. An image sensor 25 outputs an electrical signal associated with shading of an optical image of a document, which is formed on a light receiving surface by an optical imaging system (not shown) illuminated by the illumination section 28. The scan processor 26 drives the image sensor 25 and digitizes an analog signal output from the image sensor 25 and then outputs the digital signal to a RAM 22. The carriage driving section 24 causes the image sensor 25 or the optical image system to reciprocate in directions perpendicular to the main scanning direction. As a result, image data read into the scan unit 23 is stored in the RAM 22.

A print unit 8 serving as printing means includes an ink jet type print head 4, a carriage driving section 3, a paper feed section 6, a print control section 2 that controls the ink jet type print head 4, the carriage driving section 3, the paper feed section 6, and the like. On the basis of print data stored in the RAM 22, the print control section 2 causes the paper feed section 6 to transport paper in a direction perpendicular to an axis of the movement directions of the print head 4 and causes the carriage driving section 3 to reciprocate the print head 4 in directions perpendicular to the direction in which the paper is transported such that ink is ejected from the print head 4, and thus an image is formed on the paper. The print control section 2 causes the paper feed section 6 to transport a print tray 5 serving as a second unit in a direction perpendicular to the axis of the movement directions of the print head 4 and causes ink to be ejected from the print head 4 toward a label surface of the optical disk 16 mounted on the print tray 5, and thus an image is printed on the label surface of the optical disk 16.

A digital image processor 9 is a dedicated circuit, such as a DSP, which executes image processing, such as resolution conversion, unsharp processing, gray level correction, binarization, part division processing, and decoding of JPEG image data in cooperation with a CPU 20 and creates print data on the basis of image data to be printed.

A card memory interface 13 is connected to the card-type flash memory 15 inserted through a card slot 14. The card memory interface 13 reads data from the card-type flash memory 15 and transmits the read data to the RAM 22. In addition, the card memory interface 13 writes the data transmitted from the RAM 22 into the card-type flash memory 15.

An optical disk interface 11 serving as storage means and determination means reads data from the optical disk 16 inserted into a disk slot 12 as a first unit and transmits the read data to the RAM 22. In addition, the optical disk interface 11 writes the data transmitted from the RAM 22 into the optical disk 16. In the present embodiment, only a rewritable and non-volatile storage medium is a target. Accordingly, the optical disk interface 11 has a configuration based on DVD-RW, DVD-RAM, and CD-RW standards. In the present embodiment, an explanation will be made using ‘CD-RW’ as an example of the optical disk 16. Accordingly, in the subsequent description, it is assumed that ‘CD’ refers to ‘CD-RW’.

A communication unit 18 is a communication interface used when a control unit 19 communicates with an external system, such as a PC, a mobile phone, a PDA, and the like. The communication unit 18 communicates with an external system through a LAN, Internet, a USB, and the like. In addition, an interface of an external storage medium, such as the card-type flash memory 15 and a CD, may be configured as a device independent from the MFP 1 such that the interface is connected to the MFP 1 through the communication unit 18.

The control unit 19 serving as a print control device includes the RAM 22, a flash memory 21, and the CPU 20. The CPU 20 executes a control program stored in the flash memory 21 so as to control individual units of the MFP 1. The flash memory 21 is a non-volatile memory that stores the control program. The RAM 22 is a volatile memory in which a control program or image data input from the card memory interface 13, the communication unit 18, or the scan unit 23 are temporarily stored. The control program may be stored in the flash memory 21 from a distant server through a network or may be stored in the flash memory 21 through a computer-readable recording medium, such as the card-type flash memory 15. By executing a control program, the control unit 19 functions as storage means, printing means, determination means, mode selection means, control means, guidance means, and display means.

An operation unit 10 serving as mode selection means, guidance means, and display means includes an operation panel shown in FIG. 3, a graphic controller (not shown), and a button input interface circuit (not shown). An FPD (flat panel display) 38 displays a screen image based on screen data formed by the control unit 19. In addition, a screen image for realizing a GUI (graphical user interface) is simply referred to as a screen. A plurality of buttons used to operate the MFP 1 and indicators 30, 32, 35, 51, 54, and 56 for indicating the state of the MFP 1 are provided on the operation panel. A button 31 is a power button. Buttons 33, 34, 52, 53, and 55 are mode selection buttons. A button 36 is a display switching button. A button 50 is a button for switching to a setup mode. A button 39 is a button for switching to a print setting mode. A ‘Back’ button 49 is a back button used to input an instruction for returning to a last menu. In the drawing, ‘back’ is expressed as ‘B’. Buttons 45, 46, 47, and 48 are included in a cross key for menu operation. An ‘OK’ button 40 is a button used to select an item of a menu. Buttons 41 and 44 are buttons used to input an instruction for increasing or decreasing the number of sheets of paper to be set. A button 42 is a button used to input various kinds of instructions, such as start of print and start of backup. A ‘Stop’ button 43 is a button used to input an instruction for stopping processing. [0022]

Next, a format used for storing data into an optical disk in the case when the MFP 1 backs up data in the optical disk will be described.

In the present embodiment, the MFP 1 backs up data in the MPV (MultiPhoto/Video) format. The MPV format is a unified standard established by the OSTA (optical storage technology association) in order to enable image data or sound data stored in a CD to be used in any kind of device, irrespective of different file systems used in individual devices. The MPV defines that the content type, title, or path of a file stored in a CD is described in an XML-format metadata file (referred to as ‘manifesto’). Hereinafter, the configuration of a manifesto will be described using a file system based on the MPV format as an example. In addition, a manifesto stored in a root directory of a CD is referred to as a root manifesto, and a manifesto stored for every folder is referred to as a sub-manifesto.

FIG. 4 is a view for schematically explaining the configuration of a manifesto.

A root manifesto 60 is a metadata file including link information items 61 and 64, an album information item 65, and asset information items 75 and 80. Each of the information items is structured in the XML format using a tag.

Each of the link information items 61 and 64 includes a title 62 and a path 63 of a sub-manifesto 82.

An asset is a unit of an access target of a device and corresponds to one or a plurality of files. The asset information items 75 and 80 are configured to include metadata on one asset, such as a title 76, a path 77, a category name 78, and date and time of creation 79.

An album is a group of one or a plurality of assets and generally corresponds to a plurality of files. The album information item 65 includes: an album title as a name that represents a plurality of corresponding assets; and a plurality of asset information items 68, 73, and 74 corresponding to the plurality of corresponding assets. That is, the album information is information for managing metadata of a plurality of files, which are stored in a plurality of folders but can be grouped from a predetermined point of view, in a unified manner.

A sub-manifesto 83 is stored in the same folder 81 as an asset managed thereby. In other points, there is no difference between the sub-manifesto 83 and a root manifesto 60. In the case of storing the sub-manifesto 83 in the same folder 81 as an asset to be managed, a manifesto can also be backed up only by backing up data for each folder. As a result, management of data becomes easy.

Label printing completion information item 94 as attribution information is metadata indicating whether or not printing on a label surface has been performed. If the label printing completion information is recorded in the root manifesto 60, it means that the printing on a label surface is completed. On the other hand, if the label printing completion information is not recorded in the root manifesto 60, it means that the printing on a label surface has not been performed. Metadata unique to a manufacturer can be recorded in the root manifesto 60. In addition, the label printing completion information is recorded in the root manifesto 60 as metadata unique to a manufacturer of the MFP 1.

Such storage of the root manifesto 60 and the sub-manifesto 81 into a CD allows all kinds of devices based on the MPV to utilize or search an asset stored in the CD. For example, by performing a search using a category name of asset information described in the root manifesto 60 as a key, it is possible to detect all files having a specific category name set as metadata.

Next, how the MFP 1 backs up data in a CD and performs printing (hereinafter, referred to as ‘backup printing’) onto a label surface of a CD will be described.

FIGS. 5, 6, 7, and 8 are flowcharts illustrating the flow of processing in the MFP 1. FIGS. 9, 10, and 1 are views illustrating screen transition in backup printing. FIG. 11, 12, 13, and 14 are enlarged views schematically illustrating screens in backup printing.

In the MFP 1, when the mode selection button 53 is pressed to select a fan print mode, the indicator 54 lights up and processing described below starts.

In step S105, the CPU 20 causes a screen 100 to be displayed on the FPD 38 such that a user can select a mode. The screen 100 has a plurality of mode menus subordinate to the fan print mode. Icons 101, 102, and 103 denote modes subordinate to the fan print mode. If any one of the icons 101, 102, and 103 is selected by using the buttons 45 and 48 included in a cross key and the ‘OK’ button 40 is pressed, transition to a mode corresponding to the icon occurs. A text 109 is a sentence for guiding a user to perform an operation. Icons 104 and 106 and texts 105 and 107 show the correspondence relationship between buttons and processing. An icon 108 is an indicator indicating the amount of remaining ink. When the ‘OK’ button 40 is pressed in a state in which the icon 102 corresponding to an album mode is selected, the CPU 20 transitions to the album mode and proceeds to step S110. The album mode is a mode in which batch processing of data stored in the card-type flash memory 15 or the optical disk 16 is performed.

In step S110, the CPU 20 displays the screen 110 on the FPD 38 such that a user can select an operation to be performed. The screen 110 displays a menu 111 of processing operations executable in the album mode. In the album mode, the following five processing operations are executable.

‘Album creation (all backup)’ is processing for backing up all image files stored in the card-type flash memory 45 in a CD and recording a manifesto of an album including all of the image files in the CD.

‘Album creation (selective backup)’ is processing for backing up only an image file selected by a user in a CD and recording a manifesto of an album including the selected image file in the CD.

‘Album creation (backup based on date)’ is processing for backing up an image file, which was captured at a capture date designated by a user, in a CD and recording a manifesto of an album including the image file captured at the corresponding capture date in the CD.

‘Album print’ is processing for printing an image file managed as an album among image files stored in the card-type flash memory 15 or the optical disk 16.

‘Search print’ is processing for printing an image file, which is detected using a category name or date and time of creation as a key, among image files stored in the card-type flash memory 15 or the optical disk 16.

The user can select an item using buttons 46 and 47. If any one of the ‘album creation (all backup)’, ‘album creation (selective backup)’, and ‘album creation (backup based on date)’ is selected, the MFP 1 transitions to ‘backup print mode’. When the ‘OK’ button 40 is pressed in a state in which any one of the album creations is selected, the CPU 20 proceeds to step S115.

In step S115, the CPU 20 searches image files stored in the card-type flash memory 15 using the card memory interface 13 and then creates a file list for managing a group of the detected image files when one or more image files are detected. At this time, the CPU 20 displays a screen 112 in order to inform a user that the card-type flash memory 15 is being read, and after this has been read, the CPU 20 displays a screen 114 in order to inform the user of the number of detected image files. In the case when there is no image file in the card-type flash memory 15, a screen 113 is displayed, then the screen 110 is returned.

In step S120, the CPU 20 displays a screen 115 in order to guide a user to terminate connection between a personal computer (PC) and the MFP 1. The reason why such guidance is performed is because the card memory interface 13 and the optical disk interface 11 may be used by the PC connected to the communication unit 18. When the ‘OK’ button 40 is pressed, the CPU 20 proceeds to step S125.

In step S125, it is determined which processing has been selected in step S110. If it is determined that the ‘album creation (all backup)’ has been selected, the process proceeds to step S140. In addition, if it is determined that the ‘album creation (selective backup)’ has been selected, the process proceeds to step S130. In addition, if it is determined that the ‘album creation (backup based on date)’ has been selected, the process proceeds to step S135.

In step S130, the CPU 20 displays a screen 116 such that a user can select an image file to be backed up. The screen 116 displays a menu for selecting a file to be backed up. An image file detected from the card-type flash memory 15 is indicated to the user by means of an image tile 116a that is displayed on the basis of thumbnail image data or main image data or stored in the image file. A check box 116b on each image tile 116a is displayed. One of the image tiles 116a may be selected by pressing the buttons 45, 46, 47, and 48 included in the cross key. When the button 41 is pressed in a state in which the image tile 116a is selected, an image file corresponding to the selected image tile 116a is set as a file to be backed up and a check mark 116c is displayed on the check box 116b of the selected image tile 116a. If the button 44 is pressed in a state in which the image tile 116a is selected, the image file corresponding to the selected image tile 116a is excluded from objects to be backed up. If the ‘OK’ button 40 is pressed in a state in which one or more image tiles 116a are selected, files to be backed up are decided.

In step S135, the CPU 20 displays a screen 117 such that the user can select the date. The screen 117 displays a menu for selecting the date. In association with image files detected from the card-type flash memory 15, date 1117b at which the image files were created, the number 117c of image files created at the date, and an image tile 117a based on main image data or thumbnail image data stored in a representative image file of the image files created at the date are displayed on the menu. The representative image file is an image file created at an earliest time, for example. A check box 117d for selection is displayed on each date. A method of selecting the date is substantially the same as that in the case of the screen 116.

In step S140, the CPU 20 displays a screen 118 such that the user can select a category of an album. The screen 118 displays a menu for selecting a category name related to all files to be backed up. A list 118a of category names is displayed on the basis of a category group stored in the flash memory 21. In the present embodiment, since an image file detected from the card-type flash memory 15 is an object to be backed up, the CPU 20 acquires a category group corresponding to the image file from the flash memory 21 and the list 118a is displayed on the basis of the acquired category group. As a result, category names included in the category group are indicated to the user as selection candidates for the category name associated with a file to be backed up. The user can select a category using the buttons 46 and 47 included in the cross key. When the ‘OK’ button 40 is pressed in a state in which a category is selected, the category is decided.

In step S150, the CPU 20 displays a screen 119 in order to specify a non-volatile storage medium in which backup is to be performed. As described above, an external storage device may be connected to the MFP 1 through the communication unit 18. Arbitrary external storage devices, such as a device using a CD/DVD as a non-volatile storage medium, a device using an MO (magnetooptic) disk, a device using a USB memory, a device using a ZIP disk, a device using a card type memory, and a device using a hard disk, may be connected as the external storage device. The optical disk interface 11 and a list of drive names assignable to each external storage device that is connected are displayed on the screen 119. The user can select a non-volatile storage, in which backup is to be performed, by selecting a drive name by pressing the buttons 46 and 47 included in the cross key and pressing the ‘OK’ button 40.

In step S155, the CPU 20 sets ‘ON’ as an initial value for a label correspondence flag, which is a variable on the RAM 22. The label correspondence flag is a flag indicating whether or not an image can be printed on a label surface of a non-volatile storage medium. ‘ON’ means that printing is possible and ‘OFF’ means that the printing is not possible.

In step S160, the CPU 20 sets ‘ON’ as an initial value for a division flag, which is a variable on the RAM 22. The division flag is a flag indicating whether or not a non-volatile storage medium is of an exchangeable medium type. ‘ON’ means that the non-volatile storage medium is of an exchangeable medium type and ‘OFF’ means that the non-volatile storage medium is of a non-exchangeable medium type.

In step S165, the CPU 20 determines whether or not the non-volatile storage medium selected as a backup destination is of the exchangeable medium type. For example, a CD, an MO, a USB memory, a ZIP disk, or a card-type memory, is of a medium change type and a hard disk is of a non-exchangeable medium type. This determination may be made, for example, by transmitting a predetermined command to a device corresponding to the selected non-volatile storage medium. The CPU 20 proceeds to step S175 in the case of the exchangeable medium type, and the CPU 20 proceeds to step S170 in the case of the non-exchangeable medium type.

In step S170, the CPU 20 sets the division flag to ‘OFF’.

In step S175, the CPU 20 specifies whether or not the non-volatile storage medium selected as the backup destination is of a type having a printable label surface. For example, a CD or a DVD is specified as a type having a printable label surface, and a USB memory, a ZIP disk, or a card-type memory is specified as a type not having a printable label surface. The type specification may be performed, for example, by transmitting a predetermined command to a device corresponding to the selected non-volatile storage medium. The CPU 20 proceeds to step S185 in the case of the type having s printable label surface, and the CPU 20 proceeds to step S180 in the case of the type not having a printable label surface.

In step S180, the CPU 20 sets the label correspondence flag to ‘OFF’.

In step S185, the CPU 20 determines whether or not a CD is present in the disk slot 12. If it is determined that a CD is present, the CPU 20 proceeds to step S190. If it is determined that a CD is not present, the CPU 20 displays a screen (not shown) to instruct a user to insert a CD. In the case when an instruction to insert a CD is displayed, the user inserts a CD into the disk slot 12 and then presses a predetermined operation button. When the predetermined button is pressed, the CPU 20 determines again whether or not a CD is present, proceeding to step S190 if it is determined that a CD is present.

In step S190, the CPU 20 determines whether or not the CD present in the disk slot 12 is of a rewritable type. For example, a CD-RW is of a rewritable type, and a CD-ROM is of a non-rewritable type. In the case of a rewritable type, the CPU 20 proceeds to step S195. In the case of a non-rewritable type, the CPU 20 causes the CD to be ejected from the drive and displays a message (not shown) urging the user to insert a rewritable CD. The user inserts a rewritable CD into the disk slot 12 and then presses a predetermined operation button. When the predetermined button is pressed, the CPU 20 determines again whether or not the CD is of a rewritable type and proceeds to step S195 in the case of the rewritable type.

In step S195, the CPU 20 determines whether or not the label correspondence flag is ‘ON’. The CPU 20 proceeds to step S200 if it is determined that the label correspondence flag is ‘ON’ and proceeds to step S225 if it is determined that the label correspondence flag is ‘OFF’.

In step S200, the CPU 20 sets ‘ON’ as an initial value for a label print flag, which is a variable stored on the RAM 22. The label print flag is a flag indicating whether or not an image is printed on a label surface. ‘ON’ means that an image is printed on a label surface and ‘OFF’ means that the image is not printed on the label surface.

In step S205, the CPU 20 searches the CD in order to determine whether or not a manifesto is already written in the CD. If the manifesto is already written in the CD, the CPU 20 proceeds to step S210. If the manifesto is not written in the CD, the CPU 20 proceeds to step S215.

In step S210, the CPU 20 searches the written manifesto in order to determine whether or not label printing completion information is described as metadata. The CPU 20 determines that printing is possible if the label printing completion information is not described, proceeding to step S215. The CPU 20 determines that printing is not possible if the label printing completion information is described, proceeding to step S220.

In step S215, the CPU 20 describes the label printing completion information in a manifesto. Specifically, in the case when a manifesto is already written in a CD, the CPU 20 creates a new manifesto obtained by unifying information of the manifesto already written and information on data to be backed at this time and describes the label printing completion information in the created manifesto. The category name selected in step S140 is also described in asset information of the manifesto. On the other hand, in the case when the manifesto is not written in the CD, the CPU creates a manifesto on the basis of the file list created in step S115 and describes the label printing completion information in the created manifesto.

In step S220, the CPU 20 sets the label print flag to ‘OFF’.

In step S225, the CPU 20 sums up the amount of data of an image file corresponding to the processing selected in step S110 and determines whether or not the amount of data of the image file is within a free space of the CD.

In the case when the amount of data of the image file is within the free space of the CD, the CPU 20 displays a message of ‘Do you want to start backup?’, as shown in a screen 122a. When the ‘OK’ button 40 is pressed, the CPU 20 proceeds to step S230.

In the case when the amount of data of the image file exceeds the free space of the CD, the CPU 20 displays a message of ‘one CD is not enough, but do you want to start backup?’, as shown in a screen 122b. When the ‘OK’ button 40 is pressed, the CPU 20 proceeds to step S230.

In the case of backing up data in a second CD or a CD subsequent to the second CD when the amount of data of the image file exceeds the free space of the CD, the CPU 20 displays a message of ‘Do you want to continue backup?’, as shown in a screen 122c. The CPU 20 proceeds to step S230 if the ‘OK’ button 40 is pressed and terminates processing if the ‘Stop’ button 43 is pressed.

In addition, in the case when a non-volatile storage medium selected as a backup destination is of a non-exchangeable medium type, such as a hard disk, the CPU 20 terminates processing by displaying a message that backup cannot be performed if the amount of data of an image file exceeds the free space of a CD.

In step S230, the CPU 20 reads an image file corresponding to the processing selected in step S110 from the card-type flash memory 45 and backs up the read image file in the CD in the MPV format. At this time, if an old manifesto is written in a CD, the CPU 20 writes a new manifesto into the CD, sets the old manifesto not to be referred, and sets the new manifesto to be referred. Thus, the CPU 20 updates the old manifesto with the new manifesto in a pseudo manner. In this backup, the CPU 20 backs up only an image file corresponding to the amount that fits the CD if it is determined that the amount of data of the image file exceeds the free space of the CD in step S225. Since a period of time is generally required for backup, the CPU 20 displays a screen 124 in order to notify the user that backup is in progress while executing the backup.

In step S235, the CPU 20 determines whether or not the label correspondence flag is ‘ON’ and whether or not the label print flag is ‘ON’. If both the label correspondence flag and the label printing flag are ‘ON’, the CPU 20 proceeds to step S240. If any one of the label correspondence flag and the label print flag is ‘OFF’, the CPU 20 proceeds to step S245.

In step S240, the CPU 20 notifies the user that backup has been completed and guides the user to set the CD in a printer by displaying a message of ‘backup is completed. CD label printing can be performed using an image that is backed up. Please set the CD on the print tray and press the button 42’, as shown in a screen 125a. Alternatively, the CPU 20 notifies the user that backup has been completed and guides the user to set the CD in the printer by displaying a message of ‘n-th backup is completed. CD label printing can be performed using an image that is backed up. Please set the CD on the print tray and press the button 42’, as shown in a screen 125b. In the case of performing the label printing, the user holds and sets the CD on the print tray 5 in accordance with an instruction and then presses the ‘OK’ button 40. When the ‘OK’ button 40 is pressed, the CPU 20 proceeds to step S250.

In step S245, the CPU 20 displays a message of ‘backup is completed’ in order to notify the user only that ‘backup is completed, as shown in a screen 125c. In step S250, the CPU 20 automatically selects eight image files from image files that are backed up and creates a circular image 253 in which reduced images 252 of images expressed by the eight image data are disposed in a ring-shaped manner as shown in FIG. 15. As shown in the drawing, the circular image 253 is created such that a category is also printed. After creating the circular image 253, the CPU 20 controls the print unit 8 so that the image 253 is printed on a label surface of the CD set on the print tray 5. Since a period of time is generally required for printing, the CPU 20 displays a screen 126 in order to notify the user that printing is in progress while executing the printing. If the ‘stop’ button 43 is pressed while executing the printing, the CPU 20 stop printing to terminate the processing.

In step S255, the CPU 20 determines whether or not a division flag is ‘ON’. The CPU 20 proceeds to step S260 if the division flag is ‘ON’ and terminates the processing if the division flag is ‘OFF’.

In step S260, the CPU 20 determines whether or not all image files have been backed up in the CD. In the case when some of the image files cannot be backed up in step S230 because the amount of data of the image files exceeds the free space of the CD, the CPU 20 displays a screen 127 to request exchange of a CD to the user. If the ‘OK’ button 40 is pressed on the screen 127, the CPU 20 returns to step S185. In step S185, the CPU 20 repeats processing until all image files to be backed up are completely backed up and terminates the processing if all of the image files have been completely backed up.

In the MFP 1 according to the embodiment of the present invention described above, when a backup print mode is selected in step S110, data to be backed up is backed up in a CD and an image based on the data to be backed up is printed on a label surface of the CD. Therefore, printing onto the label surface can be performed when backing up data in the CD.

Furthermore, in the MFP 1, in the case of a type not having a printable label surface, a determination that printing is not possible is made and the label correspondence flag is set to ‘OFF’, as is apparent from steps S175 and S180. If the label correspondence flag is set to ‘OFF’, a determination of ‘label correspondence flag =OFF’ is made in step S235 and printing onto the label surface is skipped. Accordingly, it is possible to prevent a malfunction in which printing onto a label surface of a non-volatile storage medium not having a printable label surface is performed.

Furthermore, in the MFP 1, in the case when the label printing completion information exists in a manifesto, a determination that printing is not possible is made and the label print flag is set to ‘OFF’, as is apparent from steps S210 and S220. If the label print flag is set to ‘OFF’, a determination of ‘label print flag=OFF’ is made in step S235, a guidance to set a CD on the print tray 5 is skipped, and printing onto the label surface is skipped. Thus, it is possible to prevent an image from being overwritten on a CD, on which an image is already printed on a label surface, and to prevent an erroneous guidance of ‘please set the CD on the print tray and press the button 42’ from being performed for a user even though printing onto the label surface is not performed.

Moreover, in the present embodiment, the case in which a printing apparatus is formed using the MFP 1 has been explained as an example. However, for example, the printing apparatus may be formed using a printer, an image scanner, a CD drive, and a personal computer capable of reading and writing a card-type flash memory.

In addition, it should be understood that the present invention is not limited to the above-described embodiment but various modifications may be made within the scope without departing from the scope and spirit of the present invention.

### BRIEF DESCRIPTION OF THE DRAWINGS

FIG. 1 is a view illustrating the screen transition according to an embodiment of the present invention.

FIG. 2 is a block diagram illustrating a printing apparatus according to an embodiment of the present invention.

FIG. 3 is a view schematically illustrating a multi-function machine according to an embodiment of the present invention.

FIG. 4 is a view for schematically explaining the configuration of management data according to an embodiment of the present invention.

FIG. 5 is a flowchart illustrating the flow of processing of the printing apparatus according to the embodiment of the present invention.

FIG. 6 is a flowchart illustrating the flow of processing of the printing apparatus according to the embodiment of the present invention.

FIG. 7 is a flowchart illustrating the flow of processing of the printing apparatus according to the embodiment of the present invention.

FIG. 8 is a flowchart illustrating the flow of processing of the printing apparatus according to the embodiment of the present invention.

FIG. 9 is a view illustrating the screen transition according to an embodiment of the present invention.

FIG. 10 is a view illustrating the screen transition according to an embodiment of the present invention.

FIG. 11 is a view schematically illustrating a screen according to an embodiment of the present invention.

FIG. 12 is a view schematically illustrating a screen according to an embodiment of the present invention.

FIG. 13 is a view schematically illustrating a screen according to an embodiment of the present invention.

FIG. 14 is a view schematically illustrating a screen according to an embodiment of the present invention.

FIG. 15 is a view schematically illustrating a non-volatile storage medium according to an embodiment of the present invention.

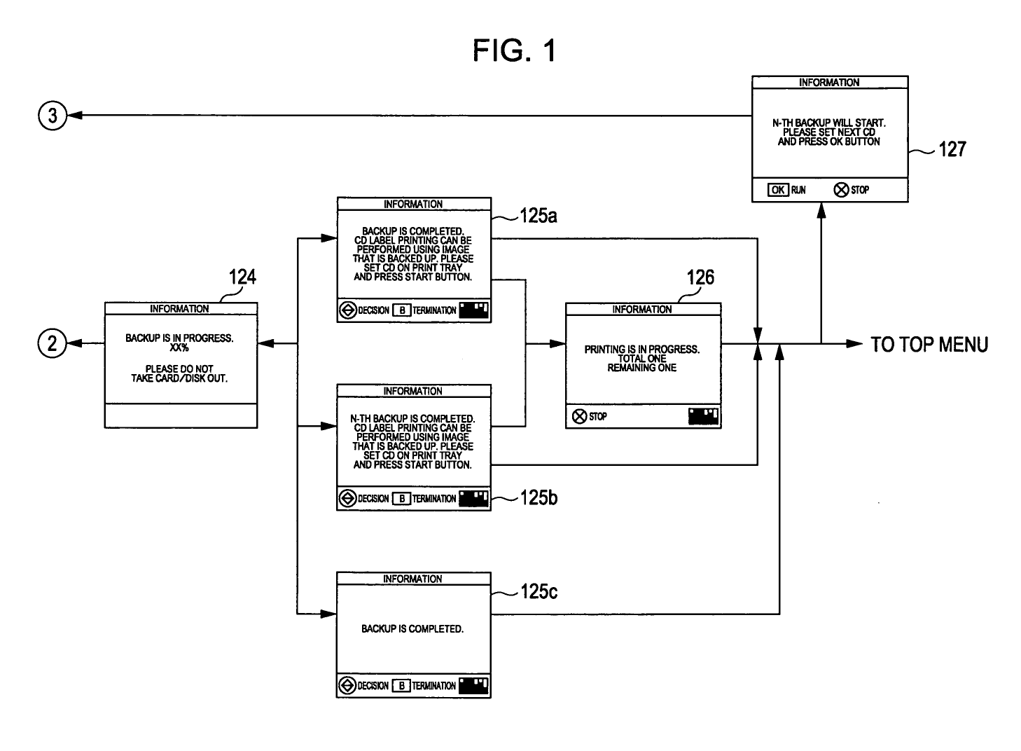

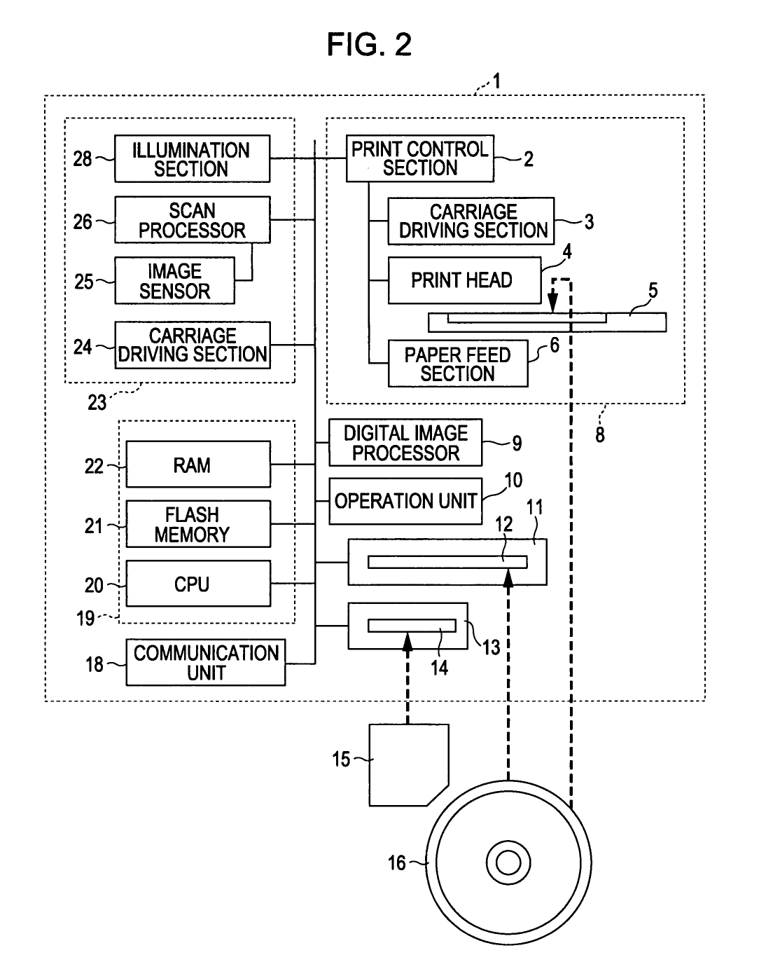

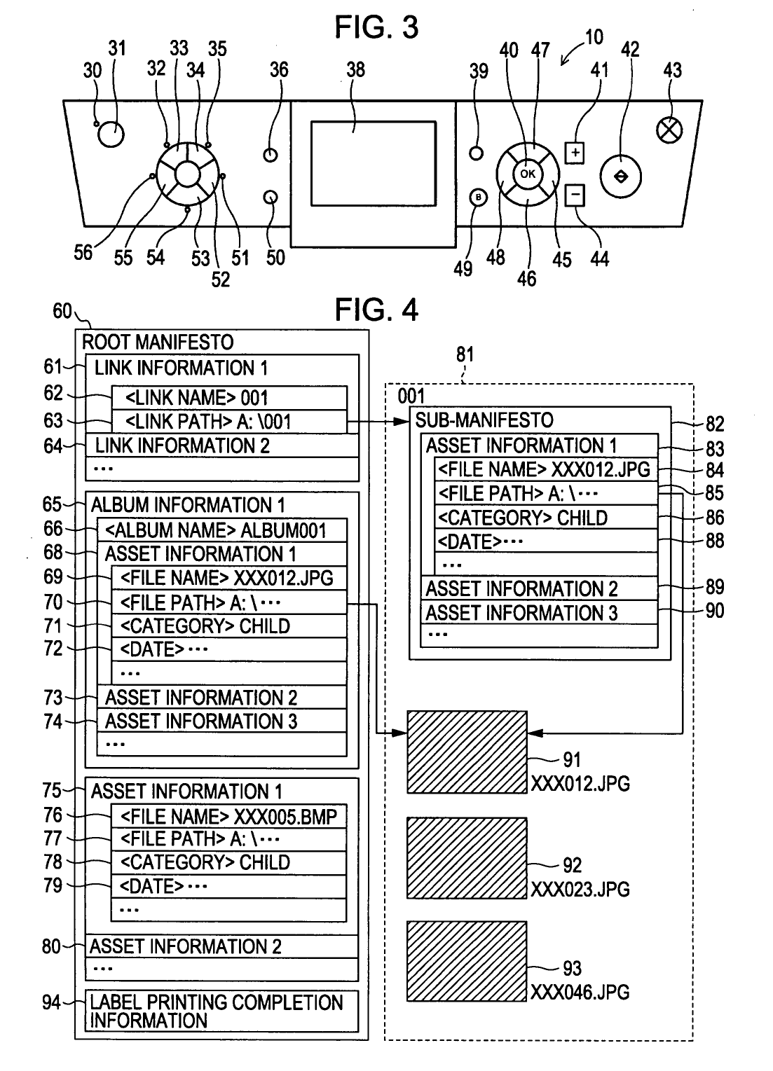

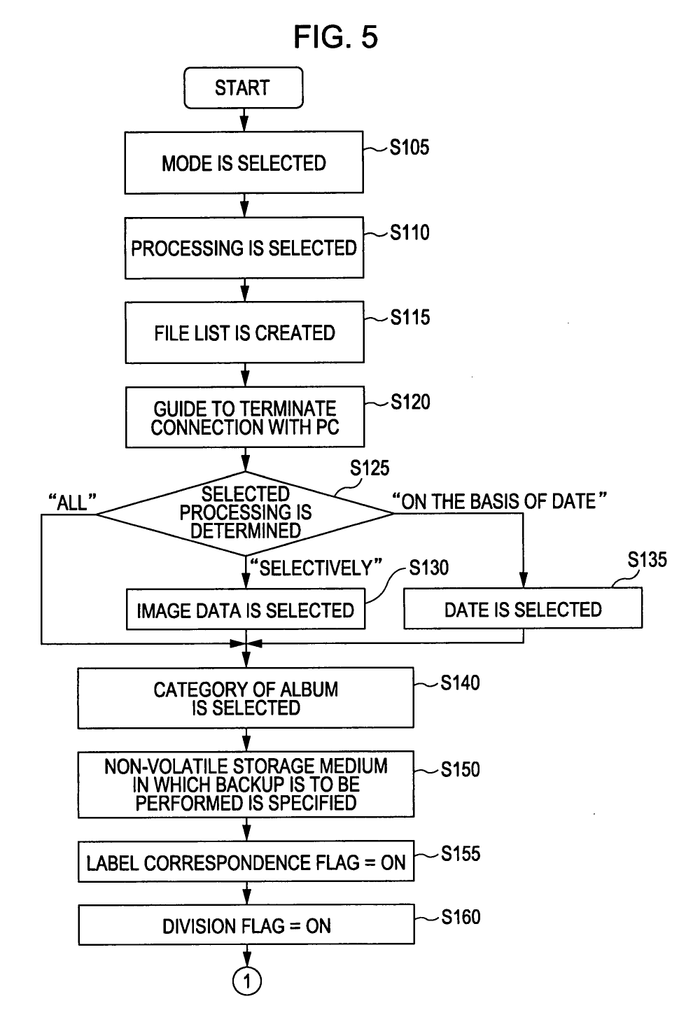

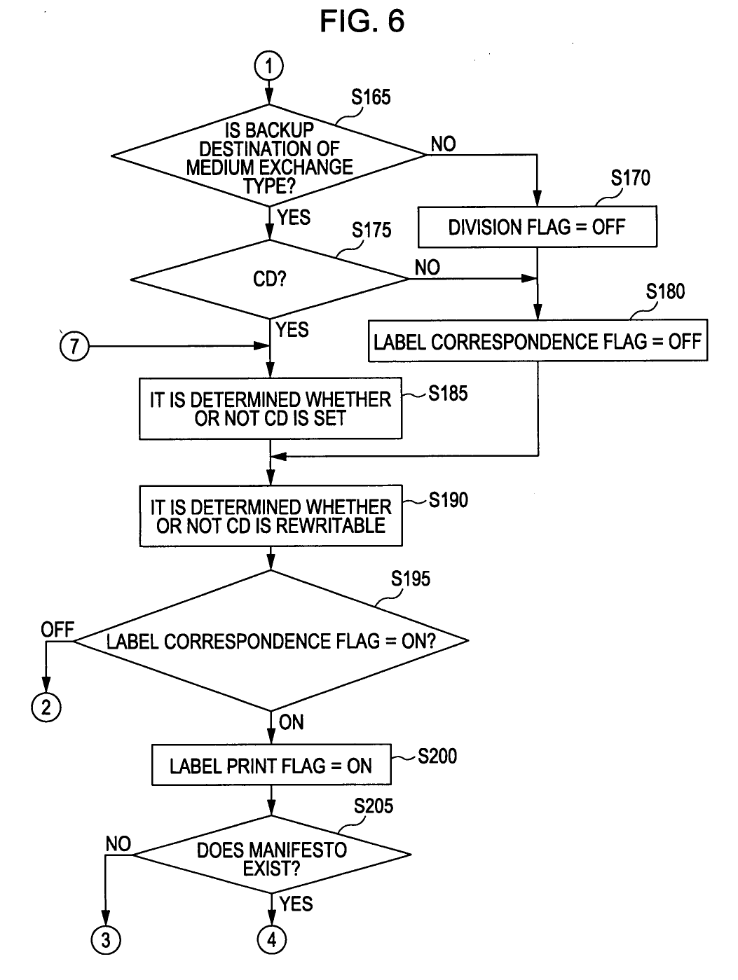

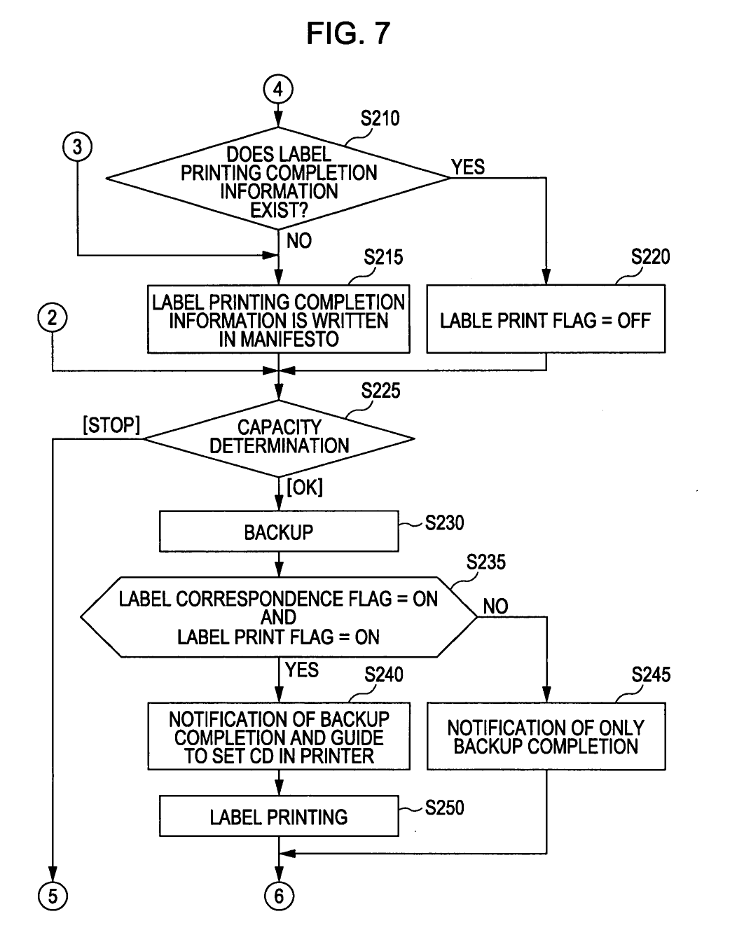

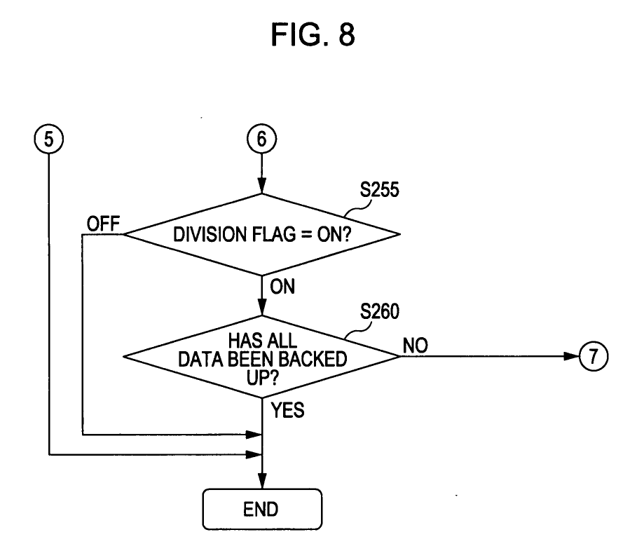

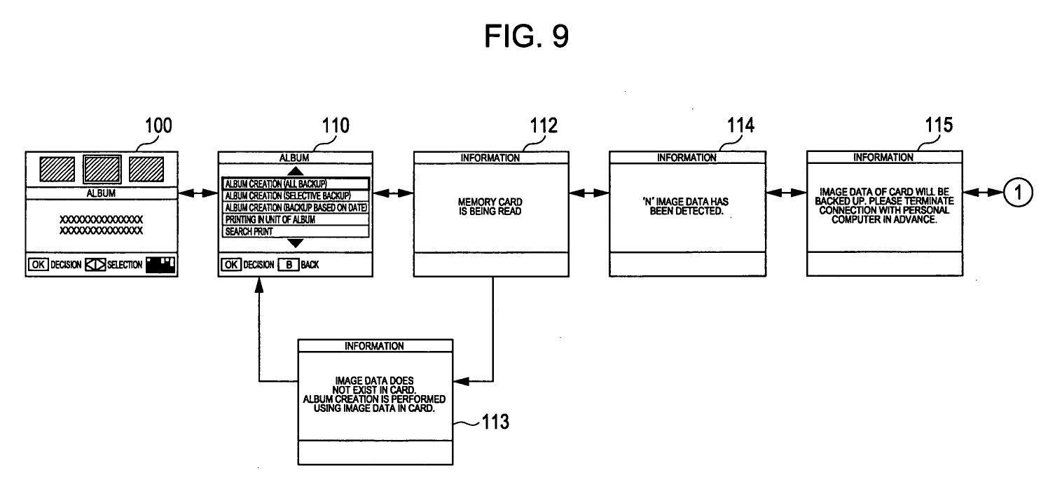

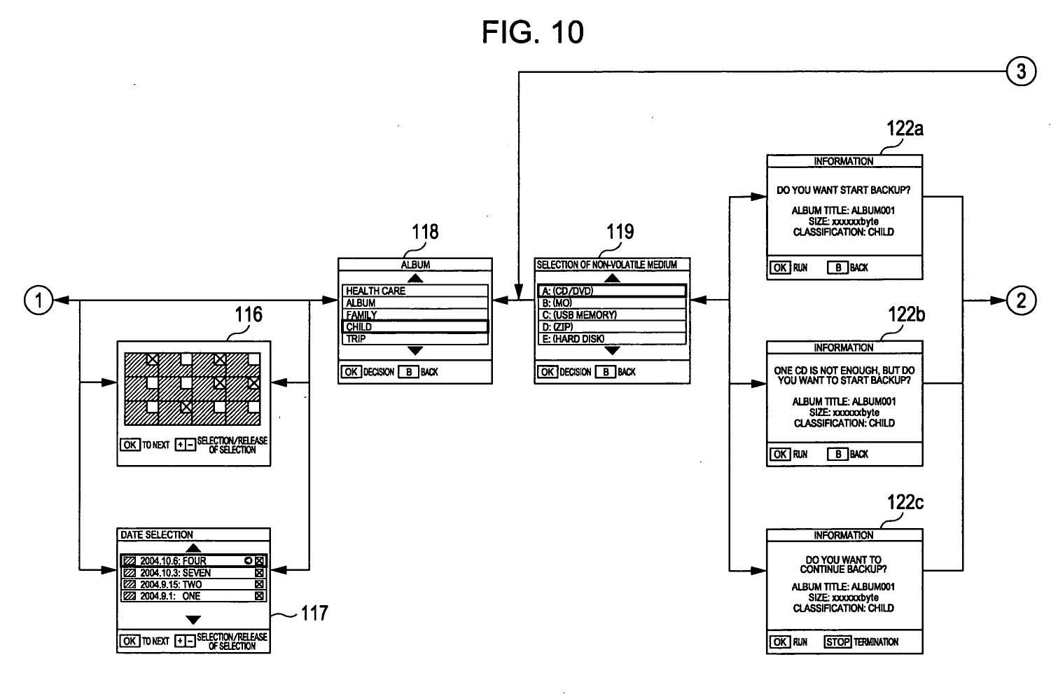

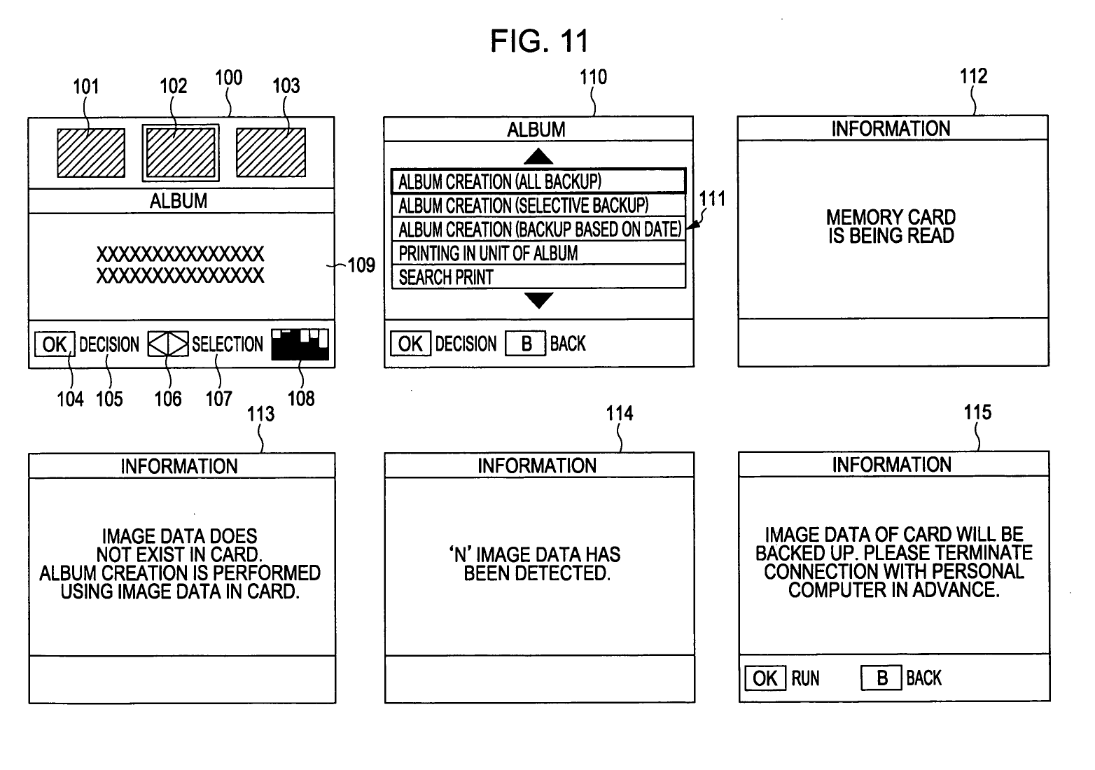

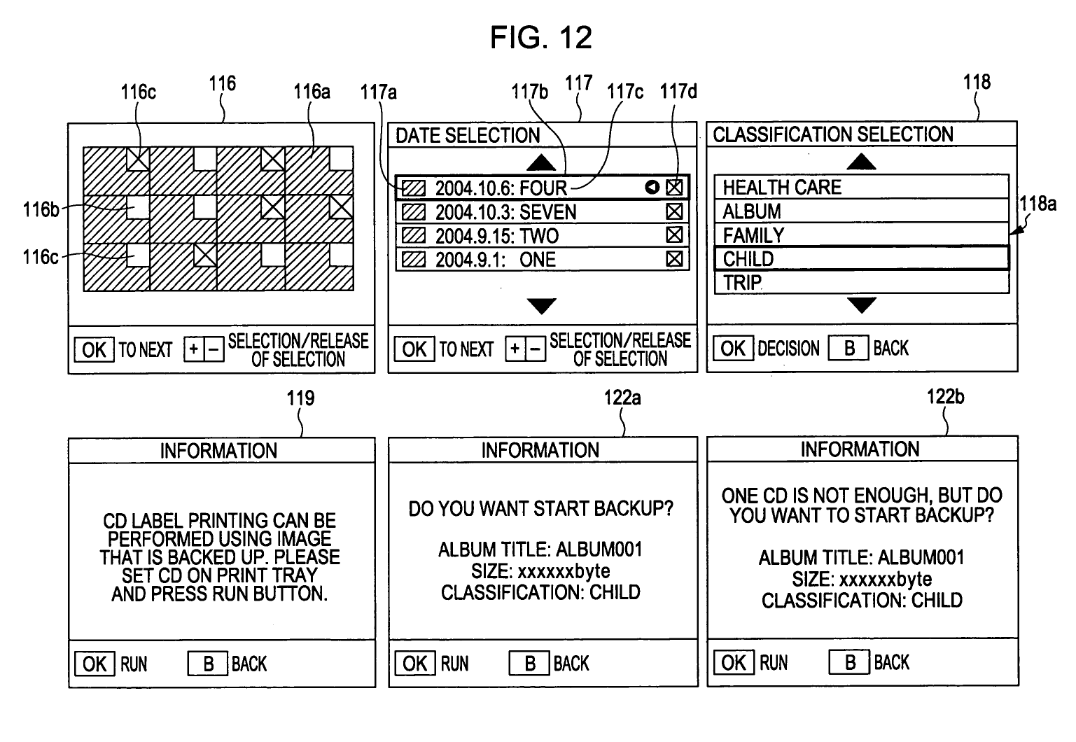

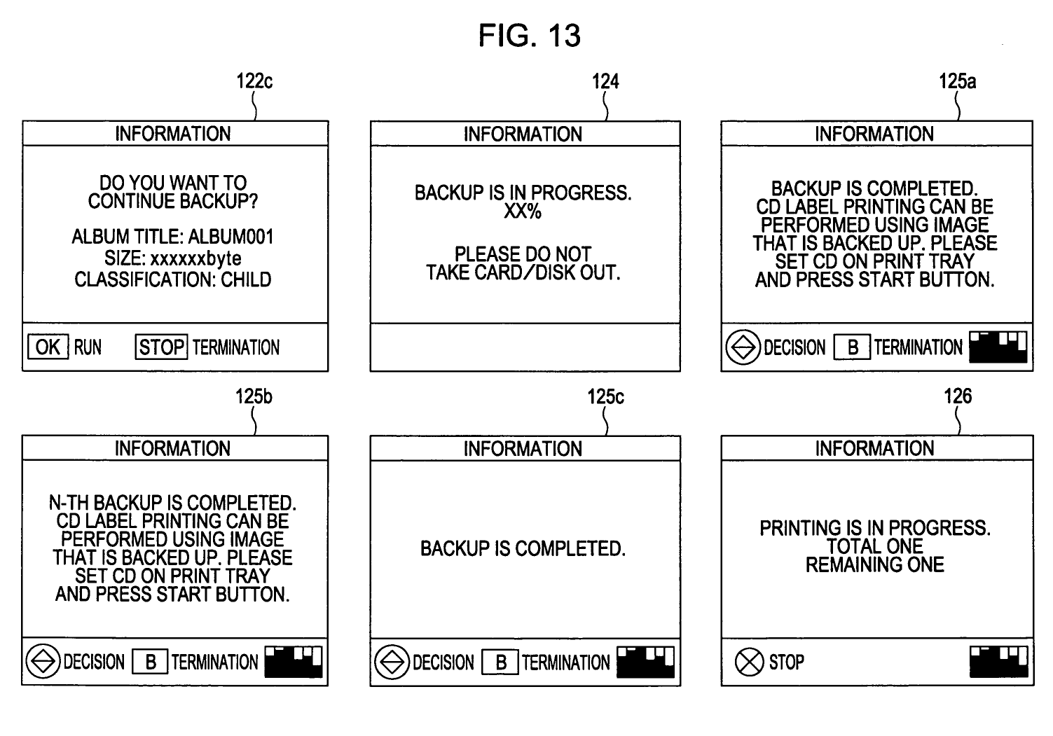

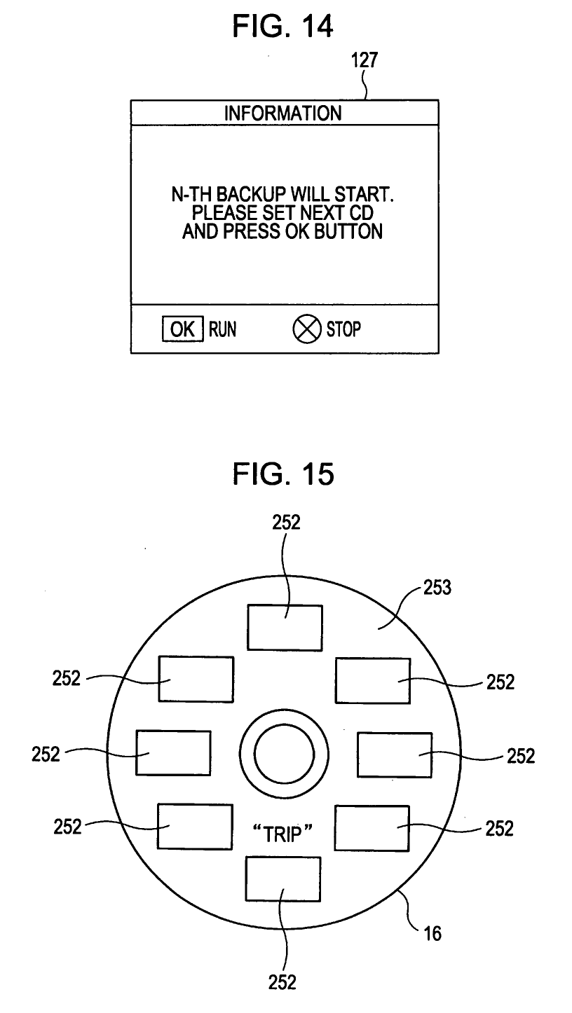

### REFERENCE NUMERALS

1: multi-function printer (printing apparatus)

5: print tray (second unit)

8: print unit (printing means)

10: operation unit (mode selection means, guidance means, display means)

11: optical disk interface (storage means, determination means)

12: disk slot (first unit)

16: optical disk (non-volatile storage medium)

19: control unit (storage means, printing means, determination means, mode selection means, control means, guidance means, display means, print control device)

1. A printing apparatus comprising:
storage means having a first unit that holds a non-volatile storage medium therein and storing data in the non-volatile storage medium held in the first unit;
printing means for printing an image on a label surface of the non-volatile storage medium having the printable label surface;
determination means for determining whether or not printing onto the label surface of the non-volatile storage medium held in the first unit is possible;
mode selection means for selecting a backup print mode; and
control means for, when the backup print mode is selected, controlling the storage means to store data to be backed up in the non-volatile storage medium held in the first unit, controlling the determination means to determine whether or not printing onto the label surface of the non-volatile storage medium is possible, and controlling the printing means to print an image based on the data to be backed up on the label surface of the non-volatile storage medium if the determination means determines that printing is possible and not to print the image if the determination means determines that printing is not possible.

2. The printing apparatus according to claim 1, further comprising:
guidance means for guiding a user to perform an operation,
wherein the printing means has a second unit, which is provided to hold a non-volatile storage medium having a printable label surface and is different from the first unit, and prints an image on the label surface of the non-volatile storage medium held in the second unit, and
the control means causes the data to be backed up to be stored in the non-volatile storage medium held in the first unit and then controls the guidance means to guide the user to insert the non-volatile storage medium into the second unit if the determination means determines that printing is possible and not to guide the user if the determination means determines that printing is not possible.

3. The printing apparatus according to claim 2,
wherein the guidance means has display means for displaying a message and performs the guiding by displaying on the display means a message instructing the non-volatile storage medium held in the first unit to be inserted into the second unit.

4. The printing apparatus according to any one of claims 1, 2 and 3,
wherein the determination means specifies the type of the non-volatile storage medium held in the first unit and determines that printing is possible if the specified type is a type having a printable label surface and determines that printing is not possible if the specified type is a type not having a printable label surface.

5. The printing apparatus according to any one of claims 1 to 4,
wherein attribute information indicating that printing is completed is stored in the non-volatile storage medium having a label surface on which an image has been printed, and
the determination means searches the non-volatile storage medium held in the first unit and determines that printing is possible if the attribute information is stored and determines that printing is not possible if the attribute information is not stored.

6. A print control device comprising:
mode selection means for selecting a backup print mode; and
control means for, when the backup print mode is selected, controlling storage means having a first unit that holds a non-volatile storage medium therein to store data to be backed up in the non-volatile storage medium held in the first unit, controlling determination means for determining whether or not printing onto a label surface of the non-volatile storage medium held in the first unit is possible to determine whether or not the printing onto the label surface of the non-volatile storage medium is possible, and controlling printing means for printing an image on the label surface of the non-volatile storage medium having a printable label surface to print an image based on the data to be backed up on the label surface of the non-volatile storage medium if the determination means determines that printing is possible and not to print the image if the determination means determines that printing is not possible.

7. A print control method comprising:
a step of selecting a backup print mode by means of mode selection means; and
a step of, when the backup print mode is selected, controlling storage means having a first unit that holds a non-volatile storage medium therein to store data to be backed up in the non-volatile storage medium held in the first unit, controlling determination means for determining whether or not printing onto a label surface of the non-volatile storage medium held in the first unit is possible to determine whether or not the printing onto the label surface of the non-volatile storage medium is possible, and controlling printing means for printing an image on the label surface of the non-volatile storage medium having a printable label surface to print an image based on the data to be backed up on the label surface of the non-volatile storage medium if the determination means determines that printing is possible and not to print the image if the determination means determines that printing is not possible, by means of control means.
